(19) United States
(12) Patent Application Publication
(10) Pub. No.: US 2008/0230953 A1
(43) Pub. Date: Sep. 25, 2008

(54) MODELING COMPOUND STAMPING TOYS AND METHODS

(76) Inventors: Thomas P. Hamilton, Cranston, RI (US); Thomas Mangiaratti, Barrington, RI (US); Grady Feren Hayes, East Greenwich, RI (US)

Correspondence Address: PERRY HOFFMAN & ASSOCIATES P.C., PO BOX 1649, DEERFIELD, IL, 60015, US

(21) Appl. No.: 11/690,672

(22) Filed: Mar. 23, 2007

(51) Int. Cl. B28B 1/29; B29C 43/00

(52) U.S. Cl. 264/310; 425/193; 425/318

(57) ABSTRACT

A modeling compound stamping tool is disclosed including a stamping element having multiple images, and a gear assembly with a handle mechanically coupled for selection of an image of the stamping element to assist in the creation of art forms, artistic designs or impressions. The described methods of stamping the modeling compounds in a toy provide the stamping element with the multiple images, and selecting an image for applying to a quantity of modeling compound. A dial or a handle is disclosed for rotating between images of the stamping element to position various different images in downwardly facing positions for pressing the stamping element against the quantity of modeling compound to produce the desired image.

### FIELD OF THE INVENTION

The present invention relates generally to toys and more particularly to activity toys with which the child forms artworks and the like into a wide variety of artistic designs or impressions.

### BACKGROUND OF THE INVENTION

Modeling compounds are well-known and commonly been used by children in their play activities. Apparatus and methods of various sophistication are known for forming modeling compound materials such as the popular PLAY-DOH TM formable material, colored plastic material, plasticene, modeling clay or the like. Such modeling compounds and the like are used by children to form a variety of shapes, articles or artwork. Modeling compounds may be molded with tools, by hand or by molds. Additionally, extrusion and template apparatus may be used. Children typically use such apparatus to fashion modeling compounds into a wide variety of desirable shapes, for example, animals, flowers, artwork or to form fanciful designs and the like.

Certain mechanisms have been employed for shaping, forming, or molding such modeling compounds are also known. U.S. Pat. No. 4,569,815 to Rentz et al. for Method and apparatus for simultaneously propelling and forming impressions with a flowable material, issued on Feb. 11, 1986 discloses a toy for extruding and molding various predetermined shapes of modeling compound or the like. In the Rentz et al. apparatus, a lever moves a piston to force the modeling compound either through an extrusion mold or into a mold cavity, so as to form the desired shapes.

It is also known to create certain forms of artworks utilizing modeling compounds. A device used to form such artworks is disclosed in U.S. Pat. No. 4,496,510 to Hanson et al. for Activity toy issued Jan. 29, 1985. With the Hanson et al. apparatus, the user may create needlecraft-like textured designs using a plastic material. Strands of the plastic material supported on a screen simulate the stands or nubs of needlecraft designs. An extruder is positioned adjacent the rear surface of the screen and moved along the screen so as to force plastic material through the screen mesh to create a needlecraft-like texture.

While children have played with modeling compound for some time, modeling compounds can be somewhat resistant to deformation by children who do not always have sufficient strength to deform the modeling compound into desired forms. This has made it difficult to form modeling compound by unique impression, extrusion or molding of the modeling compound.

It would be desirable to provide toys in the form of tools and the like as being more facilitative for use by children, especially those of early age, to assist in the creation of art forms, artistic designs or impressions.

There is a need for facilitative modeling compound stamping toys, tools and methods for use by children providing a selector such as a dial or a handle or the like for selecting between images of a stamping element to position various different images in downwardly facing positions for pressing the stamping element against the quantity of modeling compound to produce desired images.

### SUMMARY OF THE INVENTION

In accordance with the present inventions, advantageous tools, methods and modeling compound stamping apparatus provide a stamping element having a plurality of images thereon. A gear assembly and a handle are provided in mechanical communication with the stamping element for selection of an image of the plurality of images for applying to a quantity of modeling compound.

The stamping element has at least a first surface and a second surface, or a multiplicity of surfaces each of which has different images of the plurality of images. The stamping element may be provided from surfaces of a cubical stamping element, each comprising a multidimensional impression for applying a design to a quantity of modeling compound. In a described embodiment the gear assembly of the stamping element is adapted to have a gear on the stamping element being engaged by a corresponding gear in mechanical communication with the handle for rotating the plurality of images of the stamping element to position various different images thereon in downwardly facing positions for pressing the stamping element against the quantity of modeling compound to produce the desired image.

Briefly summarized, the inventions relate to modeling compound display tools and methods including a stamping element comprising a plurality of images thereon, and a selector for selecting an image of the plurality of images for applying to a quantity of modeling compound.

### BRIEF DESCRIPTION OF THE DRAWINGS

For the purpose of facilitating an understanding of the inventions, the accompanying drawings and description illustrate a preferred embodiment thereof, from which the inventions, structure, construction and operation, and many related advantages may be readily understood and appreciated.

FIG. 1A is a side elevation view of a modeling compound stamping tool embodiment according to the present invention, with FIG. 1B showing an exploded view thereof illustrating a stamping element, a gear assembly, and a handle in mechanical communication with the stamping element through the gear assembly for selection of an image from a plurality of images for applying to a quantity of modeling compound;

FIG. 2A is a perspective view of the stamping element and FIG. 2B is a plan view of the stamping element showing a gear thereon for engagement with a corresponding gear of the gear assembly in mechanical communication with the handle for rotating the plurality of images of the stamping element to position the various different images thereon in downwardly facing positions in accordance with the present invention; and

FIG. 3 illustrates a gear assembly of the present invention, and an alternate dial selector embodiment for rotating the plurality of images of the stamping element to position various different images thereon in downwardly facing positions for pressing the stamping element against the quantity of modeling compound to produce the desired image.

### DETAILED DESCRIPTION OF THE PREFERRED EMBODIMENTS

The following description is provided to enable those skilled in the art to make and use the described embodiments set forth in the best modes contemplated for carrying out the invention. Various modifications, however, will remain readily apparent to those skilled in the art. Any and all such modifications, equivalents, and alternatives are intended to fall within the spirit and scope of the present invention.

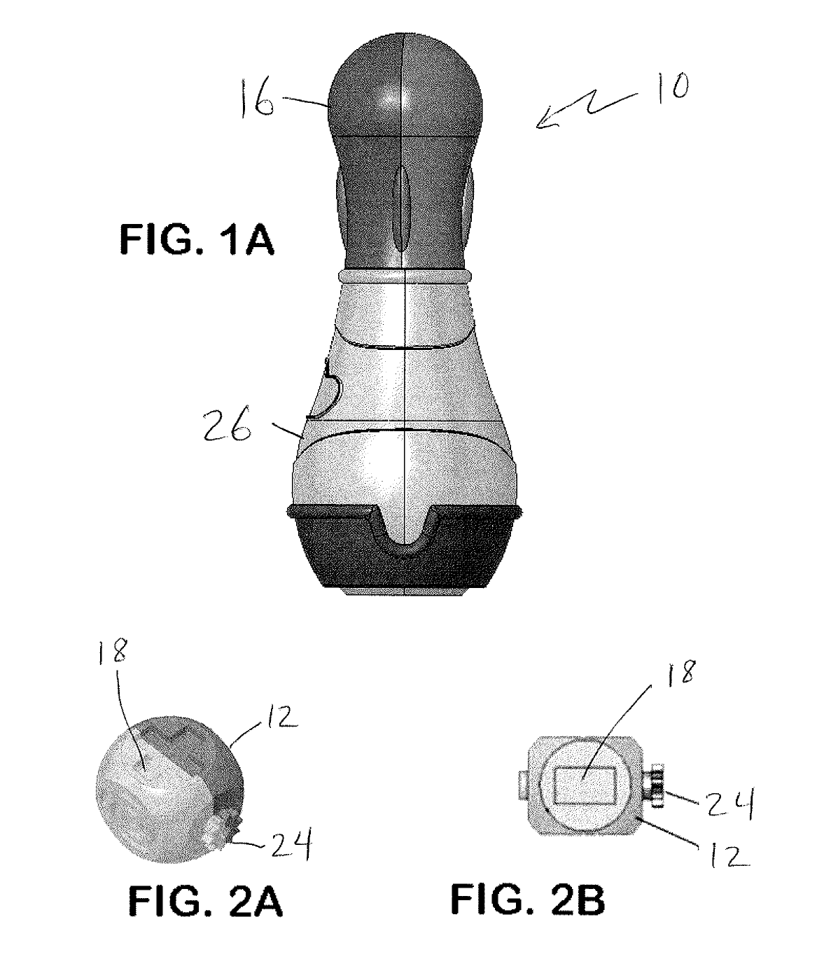

Referring now to the Figures, FIG. 1A shows a side elevation view of an embodiment of a modeling compound stamping tool 10, with FIG. 1B showing an exploded view thereof illustrating a stamping element 12, a gear assembly 14, and a handle 16 in mechanical communication with the stamping element 12 through the gear assembly 14 for selection of an image 18 from a plurality of images for applying to a quantity of modeling compound. The stamping element 12 has at least a first surface 20 and a second surface 22 of a multiplicity of surfaces each of which has different images 18 of the plurality of images. The stamping element 12 may be provided from surfaces 20, 22 of a cubical stamping element as shown. The images 18 of surfaces 20, 22 of stamping element 12 each comprise a multidimensional impression for applying a design to a quantity of modeling compound. By flattening the modeling compound and using the various stamping element 12 in which there is a selection of images 18, the child can then choose from, they can create many different shapes and colors to use as artwork or as creative expression. In the present described embodiment the gear assembly 14 of the stamping element 12 is adapted to have a gear 24 on the stamping element being engaged by a corresponding gear 38 as describe further below in mechanical communication with the handle 16 for rotating the plurality of images 18 of the stamping element 12 to position various different images 18 thereon in downwardly facing positions for pressing the stamping element 12 against a quantity of modeling compound to produce the desired image. As shown the exploded sections include a lower housing bodied 26 which houses the gear assembly 14 and stamping element 12 therein.

The lower housing body 26 further includes a bottom portion housing 28 to further enclose the stamping element 12. The handle 16 as shown in FIG. 1A is position atop the lower housing bodied 26, providing the toy stamping tool 10 in the shape of a bowling pin as shown.

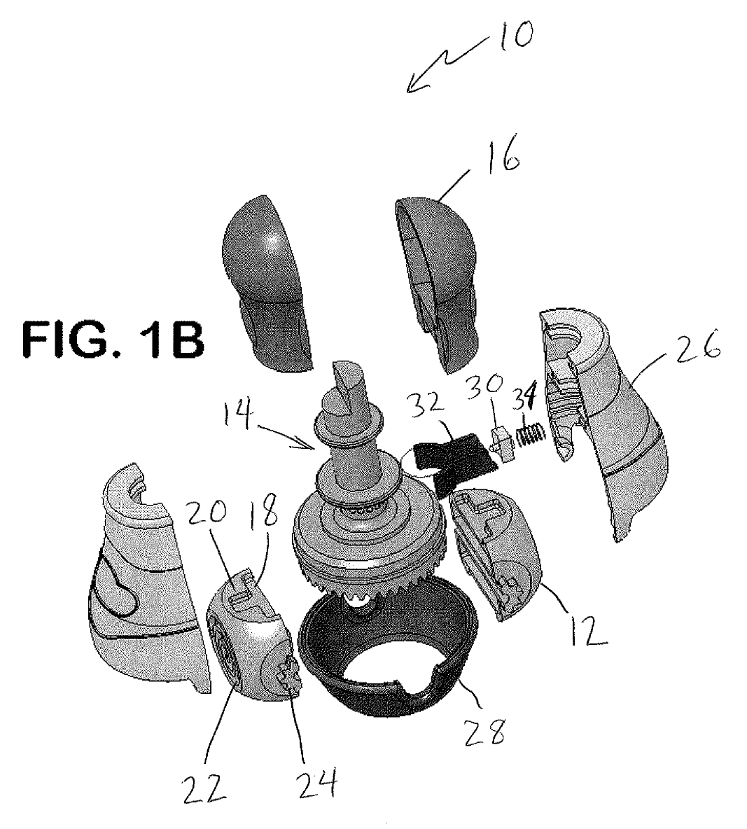

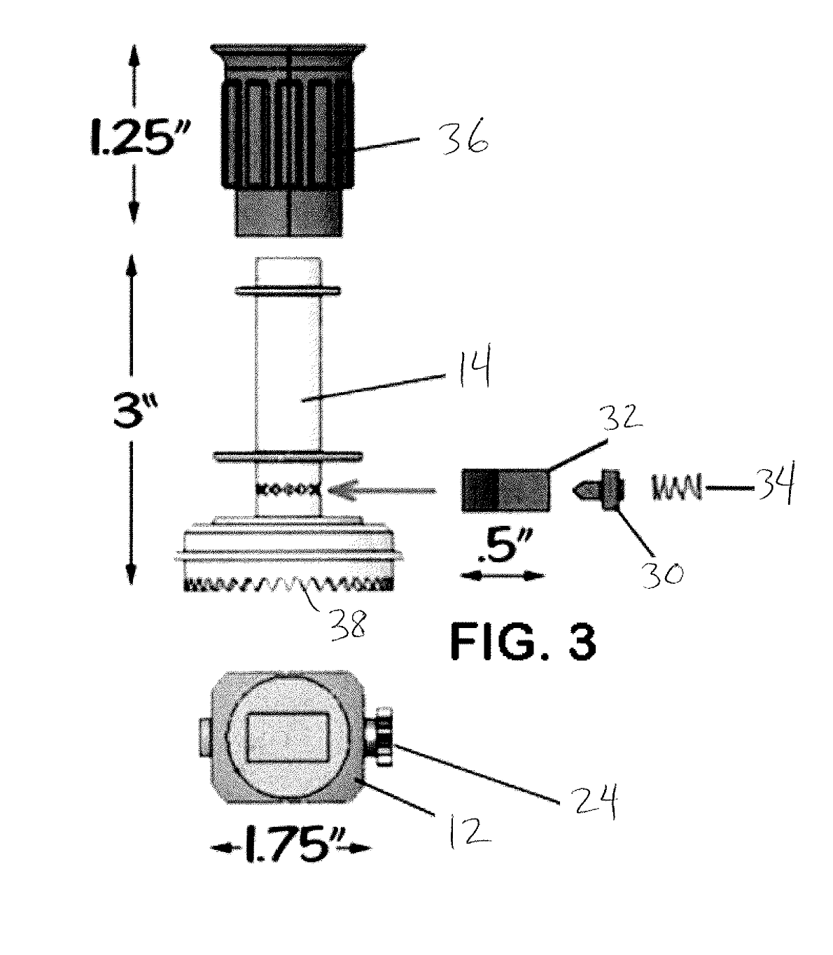

FIG. 2A and FIG. 2B show a prospective view and a plan view of the stamping element 12 respectively. As shown the stamping element 12 are provided with the gear 24 for rotatably selecting different images 18. With reference to FIG. 1B and FIG. 3 the gear assembly 14 is provided for rotatable manipulation with the handle 16, or alternatively a dial 36 which may provide indications, etc., in alternative embodiments for selection of images of 18 using the handle 16 or dial 36. The handle 16 or dial 36 are provide in mechanical communication via the gear assembly 14 included internal gears which may further include a clutch providing mechanical communication with the stamping element 12 allowing manual manipulation including a slip gear arrangement for the like preventing inadvertent malfunction or breaking of the gears if, e.g., a child holds the stamping element 12 while rotating the handle 16.

As described various selector arrangements may be employed including the handle 16 or dial 36, however various other mechanical or other selectors may be employed for selecting the image of the plurality applying to a quantity of modeling compound and creating many shapes and colors. The present described selector operates through the gear assembly 14 which further includes and alignment peg 30, peg holster 32 and a spring 34 secured with the lower housing 26, and for operative engagement between the alignment peg 30 and the gear assembly 14 for establishing alignment of the stamping element 12 in operation. Thus the gear 24 on the stamping element 12 is engaged by the corresponding gear 38 of the gear assembly 14 as shown in FIG. 3 allowing the gear assembly 14 to rotate the stamping element 12 about its axis through the arrangement of gear 24 and 38. The stamping element 12 with its different images 18 on surfaces herein provided as four sides of a cube employ the gear assembly 14 for rotating the stamping element 12 to position the various different surfaces 18 thereon in downwardly facing positions. Once a selected image has been place in the downwardly facing position on the stamping element 12, the toy stamper tool 10 can be used for pressing the stamping element against a quantity of modeling compound to produce the desired image. Thus the described methods of stamping the modeling compounds with the toy tool 10 provide the stamping element to assist in the creation of art forms, artistic designs or impressions in many colors and shapes.

From the foregoing, it can be seen that there has been provided features for improved modeling compound stamping toys and methods. While a particular embodiment of the present invention has been shown and described, it will be obvious to those skilled in the art that changes and modifications may be made without departing from the invention in its broader aspects. Therefore, the aim is to cover all such changes and modifications as fall within the true spirit and scope of the invention. The matter set forth in the foregoing description and accompanying drawings is offered by way of illustration only and not as a limitation. The actual scope of the invention is intended to be defined by subsequent claims when viewed in their proper perspective based on the prior art.

What is claimed is:

1. A modeling compound stamping tool, comprising:
a stamping element comprising a plurality of images thereon;
a gear assembly; and
a handle in mechanical communication with the stamping element through the gear assembly for selection of an image of the plurality of images for applying to a quantity of modeling compound.

2. A tool as recited in claim 1, wherein the stamping element comprises a first surface and a second surface, each of the first surface and the second surface having different images of the plurality of images.

3. A tool as recited in claim 2, wherein the stamping element comprises a multiplicity of surfaces.

4. A tool as recited in claim 3, wherein the stamping element comprises surfaces of a cubical stamping element.

5. A tool as recited in claim 3, wherein the stamping element comprises four surfaces, a multiplicity of which each comprise an image thereon.

6. A tool as recited in claim 1, wherein the plurality of images of the stamping element each comprise a multidimensional impression for applying a design to a quantity of modeling compound.

7. A tool as recited in claim 1, wherein the gear assembly of the stamping element is adapted to comprise a gear on the stamping element being engaged by a corresponding gear in mechanical communication with the handle for rotating the plurality of images of the stamping element to position various different images thereon in downwardly facing positions.

8. A tool as recited in claim 1, wherein the handle comprises a dial for selecting one of the plurality of images of the stamping element.

9. A tool as recited in claim 1, comprising a lower housing for enclosing the stamping element with the handle atop the lower housing.

10. A tool as recited in claim 9, wherein the handle and the lower housing are configured in the shape of a bowling pin.

11. A method of stamping modeling compound, comprising:
providing a stamping element with a plurality of images; and
selecting an image of the plurality of images for applying to a quantity of modeling compound.

12. A method as recited in claim 11 coupling a handle with the stamping element through the gear assembly for selecting one of the plurality of images of the stamping element.

13. A method as recited in claim 11 providing a dial in association with the stamping element for selecting one of the plurality of images of the stamping element.

14. A method as recited in claim 11, wherein the step of providing a stamping element with a plurality of images comprises providing a multidimensional impression for applying a design to a quantity of modeling compound.

15. A method as recited in claim 12, comprising enclosing the stamping element in a lower housing with the handle atop the lower housing to provide the handle for rotating the plurality of images of the stamping element to position various different images thereon in downwardly facing positions for pressing the stamping element against the quantity of modeling compound to produce the desired image.

16. A modeling compound stamping tool, comprising:
a stamping element comprising a plurality of images thereon; and
a selector for selecting an image of the plurality of images for applying to a quantity of modeling compound.

17. A tool as recited in claim 1, wherein the selector comprises a gear assembly in mechanical communication with the stamping element for selection of an image of the plurality of images.

18. A tool as recited in claim 1, comprising a gear assembly including a clutch providing mechanical communication between the selector and the stamping element for selection of an image of the plurality of images.

19. A tool as recited in claim 1, wherein the selector comprises a handle in mechanical communication with the stamping element for selection of an image of the plurality of images.

20. A tool as recited in claim 1, wherein the selector comprises a dial in mechanical communication with the stamping element for selection of an image of the plurality of images.
